(19) United States
(12) Patent Application Publication
(10) Pub. No.: US 2012/0135367 A1
(43) Pub. Date: May 31, 2012

(54) Wire Arches for Orthodontics

(76) Inventor: Rolf Foerster, Pforzheim (DE)

(21) Appl. No.: 13/377,282

(22) PCT Filed: Jun. 4, 2010
(86) PCT No.: PCT/EP10/03391

§ 371 Date: Jan. 11, 2012

(30) Foreign Application Priority Data
Jun. 12, 2009 (DE) 10 2009 025 555.9

(51) Int. Cl. A61C 7/20; B29C 65/00

(52) U.S. Cl. 433/20; 156/85

(57) ABSTRACT

The invention relates to a wire arch for use in orthodontics wherein a white or tooth-colored shrink tube is shrunk onto the wire arch.

The invention relates to archwires for orthodontics. This concerns archwires that are used in combination with brackets, which are glued to the teeth, in order to correct malpositioned teeth. When the brackets and the archwire connecting them are applied on the labial side of the teeth, the appearance of the archwire is often considered unpleasant due to its metallic grey color contrasting starkly from the color of the teeth. While there are ceramic brackets and plastic brackets available that are adapted in color to the color of the teeth, the same procedure is not feasible in the case of archwires. It is known to coat orthodontic archwires to be white, in particular by use of a synthetic resin, into which white pigments such as, for example, titanium dioxide, are embedded (U.S. Pat. No. 4,050,156 A; U.S. Pat. No. 4,722,689 A; U.S. Pat. No. 5,454,716 A; U.S. Pat. No. 4,946,387 A; U.S. Pat. No. 5,063,082 A). It is known from DE 11 2006 003 369 T5 to coat orthodontic archwires with crystalline zirconium dioxide. Unfortunately, however, said coatings are not abrasion-resistant under the conditions of use prevailing inside the mouth. For this reason, there is not yet a satisfactory solution available for a white or tooth-colored orthodontic archwire.

The present invention enables orthodontic archwires that are provided to be white or tooth-colored and are more resistant to stresses occurring inside the mouth that may lead to the archwires loosing the white color or the color of teeth, respectively.

According to claim 1, a white or tooth-colored shrink tube is shrunk onto the orthodontic archwire. According to independent claim 2, the archwire is provided with a white or tooth-colored coating and a transparent or translucent shrink tube is shrunk onto the archwire subsequently. Advantageous refinements of the invention are the subject matter of the sub-claims.

The invention has significant advantages:
The shrink tube containing or protecting the white color or tooth color is significantly more resistant to abrasion and other stresses to which it is exposed inside the mouth than a white or tooth-colored coating or layer of synthetic resin containing white or tooth-colored pigments that is applied onto the archwire. The white color or tooth color imparted on the archwire is maintained for the customary duration of treatment.
The procedure of providing an archwire to be white or tooth-colored is simple to use.
A shrink tube simply needs to be slid onto the archwire and then heated to its shrinking temperature.
Provided the archwire receives a white or tooth-colored coating first, which is then protected by a shrinking tube, there are no stringent requirements in terms of the adhesion strength of the white or tooth-colored coating, since the coating is protected and fixed in place by the shrinking tube that is shrunk onto it subsequently. The coating can be applied, e.g., by an inexpensive immersion procedure or spray procedure.
In some cases, archwires are pre-shaped by the manufacturer and supplied in pre-shaped form to orthodontics which then use the archwires in the treatment of patients. The pre-shaping of the archwires is often associated with a heat treatment, in particular when the archwires consist of a shape memory alloy having superelastic properties. Synthetic materials usually do not withstand said heat treatment. It is an advantage of the invention that shrink tubes can also be slid and shrunk onto pre-shaped and heat-treated archwires in an efficient manner and that there are no stringent technical requirements to be met by the coating procedure in cases, in which the pigments are not situated in the material of the shrink tube, but in which the archwires are coated to be white or tooth-colored before sliding and shrinking a shrink tube onto them, such that even already pre-shaped archwires can be coated inexpensively.
Shrink tubes can not only be shrunk onto orthodontic archwires having a circular cross-section, but also onto orthodontic archwires having a rectangular or square cross-section. This is particularly advantageous since white or tooth-colored coatings of orthodontic archwires having a rectangular or square cross-section have thus far been at a particular risk of abrasion or flaking of the coating.

Polytetrafluoroethylene (Teflon) is a particular well-suited material for said shrink tubes. Other well-suited materials include polyolefins, polyvinylidene fluoride (PVDF), and fluoroelastomers, such as the fluoroelastomer that is commercially available from DuPont under the trade name of Viton.

Not only stainless steels are used as material for orthodontic archwires, but also, to a large degree, superelastic shape memory alloys, in particular a binary alloy that contains nickel and titanium at approximately equal atomic percentages, which may lead to the “twinning” that is characteristic of shape memory alloys.

Orthodontic archwires having a rectangular cross-section usually have a cross-sectional area of no more than 0.40 mm². Orthodontic archwires having a circular cross-section in most cases have a diameter of no more than 0.50 mm. Brackets that are used in combination with an archwire have a slot for the archwire that takes up the archwire. The width of the slot is selected suitably such that the slot can take up an archwire having a common cross-section or common diameter. For this reason, it is preferred that archwires according to the invention including the shrink tube shrunk onto them also have a cross-section of no more than 0.40 mm² in the case of rectangular or square archwires, or a diameter of no more than 0.50 mm in the case of archwires having a circular cross-section. This means that archwires that are thinner than archwires according to the prior art need to be used. Accordingly, the thinner archwires must be capable of taking up and transferring the forces that are to take up and transfer during the correction of tooth position such that said archwires need to have a higher tensile strength and flexural strength than the archwires used so far for the same treatment task.

According to a refinement of the invention, it is preferred not to use a binary nickel-titanium alloy for archwires made of a superelastic shape memory alloy, but rather to use nickel-titanium alloys in which part of the nickel is replaced by vanadium, iron, cobalt or copper. This allows superelastic archwires to be generated which feature higher tensile and flexural strength—as desired. The alloys preferably contain no more than 10 at-%, particularly preferably no more than 6 at-%, of vanadium, iron, cobalt or copper in place of a corresponding quantity of nickel.

Preferably, the composition of the superelastic alloy, in which a part of the nickel is replaced by vanadium, iron, cobalt or copper, is selected such and is adapted to the cross-section of the archwire including the shrink tube shrunk onto it or to the diameter of the archwire including the shrink tube shrunk onto it such that the product of the tensile strength and/or flexural strength and cross-section of the naked archwire that is surrounded by a shrink tube is approximately equal to the product of the tensile strength and/or flexural strength of a superelastic archwire made of the binary nickel-titanium alloy whose cross-section is equal to the cross-section of the thinner archwire including the shrink tube situated on it and, if applicable, including the cross-section of a white or tooth-colored coating that is provided between the archwire and its shrink tube. This is advantageous in that the attending orthodontists, in practice, can presume that a white or tooth-colored archwire being provided with a shrink tube, in terms of the forces that it can transfer, behaves just like a conventional naked archwire made of a binary nickel-titanium alloy having the same external dimensions.

Archwires made of high temperature-resistant synthetic materials, in particular made of polyetherketones, are also well-suited for the purposes of the invention, since they have a sufficiently high modulus of elasticity and a sufficiently high tensile strength, can be sterilized, are biocompatible and show high chemical inertness. Unfortunately, they are brown-grey in color. However, for purposes of the invention, they can either be dyed and the dye can be protected by shrinking a transparent or translucent shrink tube onto them or they can be surrounded by a dyed shrink tube. Polyetherketones can withstand the temperatures occurring during the shrinking process: being particularly preferred, polyetheretherketone (PEEK) has a melting point of approx. 350° C., polyetherketoneketone (PEKK) has a melting point of approx. 391° C., polyetheretheretherketone (PEEEK) has a melting point of approx. 324° C.

Two exemplary embodiments of the invention are shown in the drawings. In the figures:

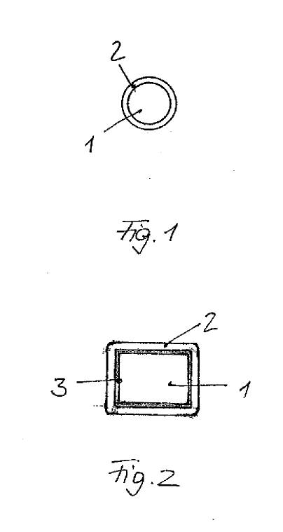

FIG. 1 shows a cross-section through a superelastic archwire with a shrink tube shrunk onto it; and

FIG. 2 shows a cross-section through a different superelastic archwire, whereby a thin white or tooth-colored coating is provided between said superelastic archwire and the shrink tube shrunk onto it.

The example presented in FIG. 1 shows a wire 1 that has a circular cross-section and is made of a superelastic alloy and has a diameter of 0.30 mm, onto which a white shrink tube 2 is shrunk, which consists, e.g., of Teflon and preferably is 0.05 mm in thickness such that the total diameter is 0.40 mm.

The exemplary embodiment presented in FIG. 2 differs from the exemplary embodiment presented in FIG. 1 in that the superelastic wire 1 has a rectangular cross-section and is provided with a white coating 3, which, e.g., consists predominantly of titanium dioxide. A shrink tube 2, which also consists, e.g., of Teflon, has been pulled over and shrunk onto it. The original shape of the cross-section of the shrink tube 2 does not necessarily have to have been rectangular as it adapts to the shape of the cross-section of the coated rectangular wire 1 due to the shrinking process. The external dimensions of the cross-section are, e.g., 0.46×0.64 mm. The thickness of the shrunk-on shrink tube 2 is 0.05 mm and the thickness of the coating 3 is, e.g., 0.03 mm. It can be provided by means of an immersion process or by spraying it on and subsequently drying it.

### LIST OF REFERENCE NUMBERS

1 Wire
2 Shrink tube
3 Coating

1. Archwire for use in orthodontics, said archwire having a white or tooth-colored shrink tube is shrunk thereonto.

2. Archwire for orthodontics, said archwire having a white or tooth-colored coating, and a transparent or translucent shrink tube shrunk onto the coated archwire.

3. Archwire according to claim 1 having a rectangular cross-section with an area of no more than 0.40 mm².

4. Archwire according to claim 1, including the shrink tube shrunk onto it, it has a total cross-section of no more than 0.40 mm².

5. Archwire according to claim 1 wherein said archwire has a circular cross-section with a diameter of no more than 0.50 mm.

6. Archwire according to claim 1, wherein said archwire including the shrink tube has a total diameter of no more than 0.50 mm.

7. Archwire according to claim 1, wherein said archwire comprises a high temperature-resistant synthetic material, a polyetherketone.

8. Archwire according to claim 1 wherein said archwire comprises a superelastic alloy, a superelastic nickel-titanium alloy containing 50 at-% nickel and 50 at-% titanium.

9. Archwire according to claim 8, wherein a part of the nickel in the nickel-titanium alloy is replaced by one or more of a group consisting of vanadium, iron, cobalt and copper.

10. Archwire according to claim 8 wherein the composition of the superelastic alloy, in which part of the nickel is replaced by vanadium, iron, cobalt or copper, is selected such and is adapted to the cross-section of the archwire including the shrink tube shrunk onto it or to the diameter of the archwire including the shrink tube shrunk onto it such that the product of the tensile strength and/or flexural strength and the cross-section of the naked archwire that is surrounded by a shrink tube is equal or approximately equal to the product of the tensile strength and/or flexural strength of the superelastic archwire made of the binary nickel-titanium alloy and its external cross-sectional dimensions which are equal to the external cross-sectional dimensions of the shrink tube on the thinner archwire, in which part of the nickel is replaced by vanadium, iron, cobalt or copper.

11. (canceled)

12. Archwire according to claim 2 wherein said archwire has a rectangular cross-section with an area of no more than 0.40 mm².

13. Archwire according to claim 2, wherein the archwire including the shrink tube it has a total cross-section of no more than 0.40 mm².

14. Archwire according to claim 2, wherein the archwire has a circular cross-section with a diameter of no more than 0.50 mm.

15. Archwire according to claim 2, wherein the archwire, including the shrink tube has a total diameter of no more than 0.50 mm.

16. Archwire according to claim 2, wherein the archwire comprises a high temperature-resistant synthetic material, a polyetherketone.

17. Archwire according to claim 2, wherein the archwire comprises a superelastic alloy, a superelastic nickel-titanium alloy containing 50 at-% nickel and 50 at-% titanium.

18. Archwire according to claim 17, wherein a part of the nickel in the nickel-titanium alloy is replaced by one or more of a group consisting of vanadium, iron, cobalt, and copper.

19. Archwire according to claim 17, wherein the composition of the superelastic alloy, in which part of the nickel is replaced by vanadium, iron, cobalt or copper, is selected such and is adapted to the cross-section of the archwire including the shrink tube shrunk onto it or to the diameter of the archwire including the shrink tube shrunk onto it such that the product of the tensile strength and/or flexural strength and the cross-section of the naked archwire that is surrounded by a shrink tube is equal or approximately equal to the product of the tensile strength and/or flexural strength of the superelastic archwire made of the binary nickel-titanium alloy whose external cross-sectional dimensions are equal to the external cross-sectional dimensions of the shrink tube on the thinner archwire, in which part of the nickel is replaced by vanadium, iron, cobalt or copper.

20. Method of preparing an archwire for use in orthodontics, having a white or tooth-colored appearance, said method comprising shrinking a white or tooth-colored shrink tube onto the archwire.

21. Method of preparing an archwire for use in orthodontics, having a white or tooth-colored appearance said method comprising, providing the archwire with a white or tooth-colored coating and protecting the coating by shrinking a transparent or translucent shrink tube onto the coated archwire.
